(19) United States
(12) Patent Application Publication
(10) Pub. No.: US 2018/0142594 A1
(43) Pub. Date: May 24, 2018

(54) METHOD FOR OPERATING A REAGENT DOSING SYSTEM, DEVICE FOR CARRYING OUT THE METHOD, CONTROL UNIT PROGRAM, AND CONTROL UNIT PROGRAM PRODUCT

(71) Applicant: Robert Bosch GmbH, Stuttgart (DE)

(72) Inventors: Marc Chaineux, Rudersberg (DE); Petr Zeman, Stuttgart (DE); Till Broestl, Plochingen (DE); Tobias Hoeffken, Stuttgart (DE)

(21) Appl. No.: 15/819,242

(22) Filed: Nov. 21, 2017

(30) Foreign Application Priority Data
Nov. 24, 2016 (DE) 10 2016 223 260.6

(51) Int. Cl. F01N 3/20; B01D 53/94; H05B 1/02

(52) U.S. Cl. CPC F01N 3/208; B01D 53/9418; F01N 2610/105; B01D 53/9495; H05B 1/0244; B01D 53/9431

(57) ABSTRACT

A method for operating a reagent dosing system (12), in which at least one dosing valve (14) doses a reagent upstream of at least one SCR catalytic converter (16) which is arranged in an exhaust-gas duct of an internal combustion engine (10), in which method the reagent, which is stored in a tank (28), is heated by means of a heater (30), and in which method a cavity (44) in the region of the heater (30) is detected on the basis of the evaluation of a characteristic variable of a measure of the heating current (32). The approach according to the invention is characterized in that, in the event of a cavity (44) being detected, a notification signal (52) is provided.

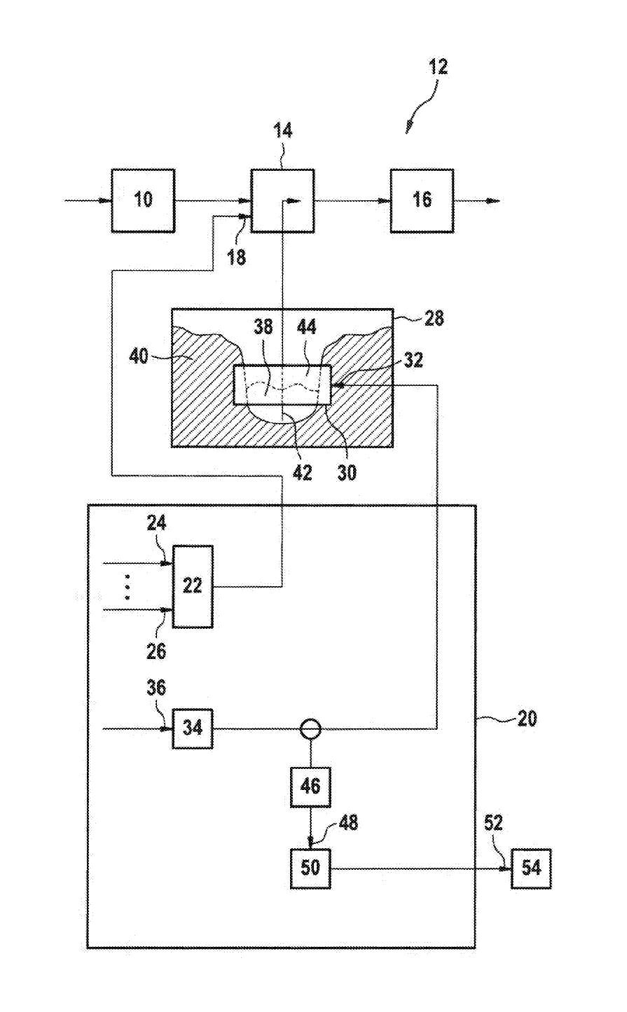

### BACKGROUND OF THE INVENTION

The present invention relates to a reagent dosing system in which at least one dosing valve doses a reagent upstream of at least one SCR catalytic converter, and to a device for carrying out the method.

The invention also relates to a control unit program which carries out all of the steps of the method according to the invention when executed on a control unit.

Finally, the invention relates to a control unit program product with program code, which is stored on a machine-readable carrier, for carrying out the method according to the invention when the program is executed on a control unit.

In order to adhere to the ever more stringent exhaust-gas legislation (Euro 6, Tier 2 Bin 5 and further emissions regulations), it is necessary to reduce nitrogen oxides (NO_{X}) in the exhaust gas of internal combustion engines, in particular of diesel engines. For this purpose, it is known for an SCR (Selective Catalytic Reduction) catalytic converter to be arranged in the exhaust-gas region of internal combustion engines, which SCR catalytic converter reduces the nitrogen oxides contained in the exhaust gas, in the presence of a reducing agent, to form nitrogen.

In this way, the fraction of nitrogen oxides in the exhaust gas can be considerably reduced. During the course of the reduction, ammonia (NH₃) is required which is admixed to the exhaust gas. Therefore, NH₃ or reagents which split to form NH₃ are dosed into the exhaust-gas duct. In general, for this purpose, use is made of an aqueous urea solution as a precursor of a reagent, which is injected into the exhaust-gas duct upstream of the SCR catalytic converter. From said solution, ammonia is formed, which acts as reducing agent. A 32.5% aqueous urea solution is commercially available under the trade name AdBlue®. In order, in an SCR catalytic converter system, to achieve high rates of conversion of the nitrogen oxides to be reduced, the SCR catalytic converter must be operated so as to be permanently filled with the reducing agent up to a certain level. DE 10 2004 031 624 A1, for example, describes how such a process implementation for an SCR catalytic converter system can be based on the ammonia fill level.

The described urea-water solution freezes below a temperature of approximately −11° C. Therefore, at low temperatures, freezing of the urea-water solution during the operation of the reagent dosing device must be prevented. The laid-open specification DE 10 2009 001 736 A1 describes a reagent dosing system in which at least one heater is provided for heating the reagent stored in a tank. For easy temperature regulation, the heater is realized with a heating element which has a PTC characteristic. For the detection of cavities in the region of the heater in the presence of frozen reagent, a variable which is characteristic of the heating current is measured. If a cavity forms, the temperature of the heating element very quickly rises owing to the progressive elimination of the thermal coupling to the reagent, such that a corresponding rapid reduction of the heating current occurs. The presence of cavities is inferred on the basis of an evaluation of a characteristic variable of the heating current, from a comparison variable which represents a state without cavities.

### SUMMARY OF THE INVENTION

The invention is based on the object of specifying a method for operating a reagent dosing device which makes a sufficient amount of reagent for the dosing available in all operating states, even in the event of an onset of cavity formation in the presence of frozen reagent, and a device for carrying out the method.

The approach according to the invention for operating a reagent dosing system, in which at least one dosing valve doses a reagent upstream of at least one SCR catalytic converter which is arranged in an exhaust-gas duct of an internal combustion engine, in which method the reagent, which is stored in a tank, is heated by means of a heater, and in which method a cavity in the region of the heater is detected on the basis of the evaluation of a characteristic variable of at least one measure of the heating current, is characterized in that, in the event of a cavity being detected, a notification signal is provided.

The notification signal indicates the presence of a cavity, and may for example trigger a notification and/or a warning.

The notification signal is preferably output on a display which prompts an operator of the internal combustion engine to replenish reagent. As a result of the replenishment, it is ensured that a sufficient amount of liquid reagent is available such that a predefined dosing rate can be maintained.

The device according to the invention provides a control unit which is specially configured for carrying out the method according to the invention.

The control unit program according to the invention can carry out all of the steps of the method according to the invention when executed on a control unit.

For this purpose, the control unit program product according to the invention, with program code which is stored on a machine-readable carrier, can carry out the method according to the invention when the program is executed on a control unit.

### BRIEF DESCRIPTION OF THE DRAWING

Exemplary embodiments of the invention are illustrated in the drawing and will be discussed in more detail in the following description.

The figure shows a reagent dosing system according to an embodiment of the invention.

### DETAILED DESCRIPTION

The figure shows an internal combustion engine 10, in the exhaust-gas region of which there is provided a reagent dosing system 12 for the purification of the exhaust gas of the internal combustion engine 10. The reagent dosing system 12 comprises at least one dosing valve 14, which doses a reagent upstream of at least one SCR catalytic converter 16.

The reagent is intended to be the urea-water solution mentioned in the introduction, which constitutes a precursor of the actual reagent ammonia, which is required in the SCR catalytic converter 16 for the conversion of NOx components of the exhaust gas of the internal combustion engine 10.

The dosing valve 14 is actuated by a dosing signal 18 which is provided by a control unit 20. The dosing signal 18, which defines the dosing rate of the reagent, is defined in a dosing signal determination means 22 in a manner dependent, for example, on the load 24 of the internal combustion engine and/or on a NOx signal 26 which is provided by at least one NOx sensor arranged in the exhaust-gas duct of the internal combustion engine 10. It is alternatively or additionally possible for further operating variables of the internal combustion engine 10 and/or characteristic variables of the exhaust gas and/or of the SCR catalytic converter 16 to be taken into consideration.

The reagent is stored in a tank 28. In the case of a urea-water solution, freezing is to be expected below approximately −11° C. To prevent the freezing or to store a reagent that has already frozen in the tank 28, a heater 30 is provided which is preferably realized as a PTC element, which is described in the prior art, described in the introduction, as per the laid-open specification DE 10 2009 001 736 A1. During the heating operation, the PTC element 30 is flowed through by a heating current 32. The heating current 32 may be defined by a heating signal determination means 34, for example in a manner dependent on the ambient temperature 36. Owing to the self-regulating characteristics of the PTC element 30, it may suffice for the PTC element to be switched to a constant voltage during heating operation, because the current is self-regulated in a manner dependent on the temperature of the PTC element 30.

The figure shows a state of the reagent in the tank 28 in which the reagent is present partially in the form of liquid reagent 38 and partially in the form of frozen reagent 40. The heater 30 is advantageously arranged in the region of a suction device 42 for the reagent. In the state illustrated in the figure, it is assumed that the liquid reagent 38 is present in the region of the suction device 42, such that a predefined dosing rate can be maintained. A critical state is assumed if a cavity 44 has already formed in the region of the heater 30, which can have the result that the frozen reagent 40 can no longer be thawed quickly enough in order to be able to maintain the demanded dosing rate.

The detection of a cavity 44 that may have formed in the region of the heater 30 can be detected on the basis of a characteristic variable of the heating current 32. For this purpose, the heating current 32, which is detected by a current sensor (not shown in any more detail) which may for example be realized as a resistive sensor or as an inductive sensor, is processed by a measurement value processing means 46 and made available as a measurement signal 48 to a signal evaluation means 50. As a characteristic variable of the measurement signal 48 which reflects a measure of the heating current 32, it is for example possible for the maximum current to be detected. Alternatively or in addition, a measure of the resistance of the heater 30 may be detected. The detection of a possibly present cavity 44 on the basis of a characteristic variable of the heating current 32 is described in detail in the prior art, described in the introduction, as per the laid-open specification DE 10 2009 001 736 A1, to which reference is explicitly made.

After a possibly present cavity 44 has been detected in the signal evaluation means 50, the signal evaluation means 50 provides a notification signal 52. The notification signal 52 may be used to indicate only the occurrence of a cavity 44 or may preferably be used as a basis for a warning notification.

The notification signal 52 is preferably made available to a display 54, on which, for example, a corresponding text message may be displayed. Such a text message preferably prompts an operator of the internal combustion engine 10 to replenish reagent. In the case of prompt replenishment of the reagent, it is ensured that a sufficient amount of liquid reagent 38 is available in order to be able to maintain the required dosing rate.

1. A method for operating a reagent dosing system (12), in which at least one dosing valve (14) doses a reagent upstream of at least one SCR catalytic converter (16) which is arranged in an exhaust-gas duct of an internal combustion engine (10), the method comprising:
heating the reagent, which is stored in a tank (28), by a heater (30),
detecting a cavity (44) in the region of the heater (30) by evaluating a characteristic variable of a measure of a heating current (32), and
providing a notification signal (52) in the event of a cavity (44) being detected.

2. The method according to claim 1, wherein the notification signal (52) is a text message on a display (54).

3. A device for operating a reagent dosing system (12), comprising a specially configured control unit (20) which carries out the method of claim 1.

4. A non-transitory machine-readable medium having a control unit program which carries out the method of claim 1 when executed on a control unit (20).
